(19) United States
(12) Patent Application Publication
(10) Pub. No.: US 2024/0409673 A1
(43) Pub. Date: Dec. 12, 2024

(54) PROCESS FOR FORMING A ZIEGLER-NATTA CATALYST COMPONENT

(71) Applicant: Borealis AG, Vienna (AT)

(72) Inventors: Kumudini Jayaratne, Porvoo (FI); Hanna- Leena Rönkkö, Porvoo (FI); Pavel Shutov, Linz (AT); Joana Elvira Kettner, Linz (AT); Jukka-Pekka Parjanen, Porvoo (FI); Emilia Tiitinen, Porvoo (FI)

(21) Appl. No.: 18/699,374

(22) PCT Filed: Oct. 13, 2022
(86) PCT No.: PCT/EP2022/078455

§ 371 Date: Apr. 8, 2024

(30) Foreign Application Priority Data
Oct. 14, 2021 (EP) 21202675.1

(51) Int. Cl. C08F 10/06

(52) U.S. Cl. CPC C08F 10/06

(57) ABSTRACT

A process for forming a Ziegler-Natta catalyst component, wherein a certain combination of washing steps is employed, enabling the provision of inventive catalysts capable of synthesising polypropylenes with increased melting temperature, decreased XCS content, as well as more efficiently maintaining catalyst activity across sequential polymerization processes.

### FIELD OF THE INVENTION

The present invention is related to a process for forming a Ziegler-Natta catalyst component involving a certain combination of washing steps, a Ziegler-Natta composition comprising said Ziegler-Natta catalyst component and a process for (co-)polymerizing propylene in the presence of a Ziegler-Natta catalyst system comprising said Ziegler-Natta catalyst composition.

### BACKGROUND TO THE INVENTION

Ziegler-Natta (ZN) type polyolefin catalysts are well known in the field of polymers, generally, they comprise (a) at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), and, optionally, a compound of group 13 of the Periodic Table (IUPAC) and/or an internal donor compound. ZN catalyst may also comprise (b) further catalyst component(s), such as a cocatalyst and/or an external donor.

A great variety of Ziegler-Natta catalysts have been developed to fulfill the different demands in reaction characteristics and for producing poly (alpha-olefin) resins of desired physical and mechanical performance. Various methods for preparing ZN catalysts are known in the state of art. In one known method, a supported ZN catalyst system is prepared by impregnating the catalyst components on a particulate support material. In WO-A-01 55 230, the catalyst component(s) are supported on a porous, inorganic or organic particulate carrier material, such as silica.

In a further well known method the carrier material is based on one of the catalyst components, e.g. on a magnesium compound, such as MgCl₂. This type of carrier material can also be formed in various ways. EP-A-713 886 of Japan Olefins describes the formation of MgClzadduct with an alcohol which is then emulsified and finally the resultant mixture is quenched to cause the solidification of the droplets. Alternatively, EP-A-856 013 of BP discloses the formation of a solid Mg-based carrier, wherein the Mg-component containing phase is dispersed to a continuous phase and the dispersed Mg-phase is solidified by adding the two-phase mixture to a liquid hydrocarbon. The formed solid carrier particles are normally treated with a transition metal compound and optionally with other compounds for forming the active catalyst.

Accordingly, in case of external carriers, some examples of which are disclosed above, the morphology of the carrier is one of the defining factors for the morphology of the final catalyst.

WO-A-00 08073 and WO-A-00 08074 describe further methods for producing a solid ZN-catalyst, wherein a solution of a Mg-based compound and one or more further catalyst compounds are formed and the reaction product thereof is precipitated out of the solution by heating the system. Furthermore, EP-A-926 165 discloses another precipitating method, wherein a mixture of MgCl₂ and Mg-alkoxide is precipitated together with a Ti-compound to give a ZN catalyst.

EP-A-83 074 and EP-A-83 073 of Montedison disclose methods for producing a ZN catalyst or a precursor thereof, wherein an emulsion or dispersion of Mg and/or Ti compound is formed in an inert liquid medium or inert gas phase and said system is reacted with an Al-alkyl compound to precipitate a solid catalyst. According to the examples, said emulsion is then added to a larger volume of A1-compound in hexane and prepolymerized to cause the precipitation.

In polymerization process this causes in turn undesired and harmful disturbances, like plugging, formation of polymer layer on the walls of the reactor and in lines and in further equipment, like extruders, as well decreased flowability of polymer powder and other polymer handling problems.

EP 1403292 A1, EP 0949280 A1, U.S. Pat. Nos. 4,294,948A, 5,413,979A and 5,409,875A as well as EP 1273595 A1 describe processes for the preparation of olefin polymerization catalyst components or olefin polymerization catalysts as well as processes for preparing olefin polymers or copolymers.

Whilst a great number of alternative ZN catalyst preparations have been developed, there remains a need to access further catalysts that enable the production of polypropylenes having finely tuned mechanical properties, in particular increased crystallinity, linked to increased melting temperature and reduced XCS content. Furthermore, it is desirable to have catalysts with as low a reduction in activity as possible in each step of a sequential polymerization process. In particular, if such an amended method were the result of simple changes to a single step of the catalyst preparation, then this modification could easily be applied to a broad range of existing catalyst preparation processes.

### SUMMARY OF THE INVENTION

The present invention is based upon the finding that modifying the washing steps during the catalyst preparation process can enable the provision of catalysts having improved properties for the polymerization of propylene.

The present invention is consequently directed to a process for forming a Ziegler-Natta catalyst component, said process comprising, in the given order, the steps of:
a) providing a solution of at least one magnesium component,
b) adding said solution from step a) to a titanium (IV) compound, obtaining thereby solid catalyst component particles as a suspension,
c) recovering said solid catalyst component particles from the suspension resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, preferably selected from toluene, hexane or pentane and optionally internal electron donor (ID),
d2) one or more washes with a wash solution of titanium tetrachloride and internal electron donor (ID), and
d3) one or more washes with a wash solution of aromatic and/or aliphatic hydrocarbon, preferably selected from toluene, hexane or pentane,
wherein at least one of the one or more washes with a wash solution of titanium tetrachloride and internal electron donor (ID) of step d2) is conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C.

In a further aspect, the present invention is directed to a Ziegler-Natta catalyst composition comprising a Ziegler Natta catalyst component obtainable by the process according to the present invention.

In another aspect, the present invention is directed to a process for the production of a polypropylene composition, comprising the polymerization of propylene, optionally with comonomers selected from C2 or C4 to C12 alpha olefins in the presence of a Ziegler-Natta catalyst system comprising a Ziegler Natta catalyst composition according to the present invention, a co-catalyst (Co) and optionally an external donor (ED).

In yet another aspect, the present invention is directed to a process for the production of a polypropylene composition, said process comprising, in the given order, the steps of:
a) providing a solution of at least one magnesium component,
b) adding said solution from step a) to a titanium (IV) compound, obtaining thereby solid catalyst component particles,
c) recovering said solid catalyst component particles from the solution resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, preferably selected from toluene, hexane or pentane, and optionally internal electron donor (ID),
d2) one or more washes with a wash solution of titanium tetrachloride and internal electron donor (ID), and
d3) one or more washes with a wash solution of aromatic and/or aliphatic hydrocarbon, 10 preferably selected from toluene, hexane or pentane, wherein at least one of the one or more washes with a wash solution of titanium tetrachloride and internal electron donor (ID) of step d2) is conducted at a temperature in the range from 80 to 120° C., more preferably in the range from 85 to 120° C., yet more preferably in the range from 85 to 115° C., still more preferably in the range from 90 to 110° C., most 15 preferably in the range from 95 to 105° C., and
polymerizing propylene, optionally with comonomers selected from C2 or C4 to C12 alpha olefins in the presence of a Ziegler-Natta catalyst system comprising a Ziegler Natta catalyst composition comprising the solid catalyst component recovered in step e), a co-catalyst (Co) and optionally an external donor (ED).

In a final aspect, the present invention is directed to a use of the Ziegler-Natta catalyst composition according to the present invention, together with a co-catalyst (Co) and an optional external donor (ED), for the polymerization of propylene, optionally with comonomers selected from C2 or C4 to C12 alpha olefins.

### DEFINITIONS

Unless defined otherwise, all technical and scientific terms used herein have the same meaning as commonly understood by one of ordinary skill in the art to which the invention pertains. Although, any methods and materials similar or equivalent to those described herein can be used in practice for testing of the present invention, the preferred materials and methods are described herein. In describing and claiming the present invention, the following terminology will be used in accordance with the definitions set out below.

Unless clearly indicated otherwise, use of the terms “a,” “an,” and the like refers to one or more.

A propylene homopolymer is a polymer that essentially consists of propylene monomer units. Due to impurities especially during commercial polymerization processes, a propylene homopolymer can comprise up to 1.0 mol % comonomer units, preferably up to 0.5 mol % comonomer units, more preferably up to 0.1 mol % comonomer units, yet more preferably up to 0.05 mol % comonomer units and most preferably up to 0.01 mol % comonomer units. It is particularly preferred that propylene is the only detectable monomer.

A propylene random copolymer is a copolymer of propylene monomer units and comonomer units, preferably selected from ethylene and C4-C12 alpha-olefins, in which the comonomer units are distributed randomly over the polymeric chain. A propylene random copolymer can comprise comonomer units from one or more comonomers different in their amounts of carbon atoms. In the following, amounts are given in % by weight (wt.-%) unless it is stated otherwise.

In the context of the present invention, a washing step is a step in which the catalyst particles are brought into contact with a washing solution for a certain amount of time, usually with stirring. Following this amount of time, the suspension is allowed to settle and the washing solution is removed. Fresh washing solution is added for further washes. The skilled person would therefore understand that two subsequent washes with the same specified wash solution would not be the same as a single washing step with twice the duration, since the second specified wash would be with fresh washing solution, rather than the potentially contaminated solution that is present at the end of the first wash.

Furthermore, in the context of the present invention, when a washing solution is specified as being a washing solution of component A, or a washing solution of component A and component B, no further components beyond the specified components may be present. In other words, “washing solution of component A” is to be interpreted as “washing solution consisting of component A”. This definition is specific to the term “washing solution”. The term “a solution of component A”, on the other hand, implies the presence of at least one solvent, in addition to component A.

### DETAILED DESCRIPTION

### Catalyst Preparation

The process according to the present invention is a process for forming a Ziegler-Natta catalyst component, said process comprising, in the given order, the steps of:
a) providing a solution of at least one magnesium component,
b) adding said solution from step a) to a titanium (IV) compound, obtaining thereby solid catalyst component particles as a suspension,
c) recovering said solid catalyst component particles from the suspension resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, preferably selected from toluene, hexane or pentane, and optionally internal electron donor (ID),
d2) one or more washes with a wash solution of titanium tetrachloride and internal electron donor (ID), and
d3) one or more washes with a wash solution of aromatic and/or aliphatic hydrocarbon, preferably selected from toluene, hexane or pentane,
wherein at least one of the one or more washes with a wash solution of titanium tetrachloride and internal electron donor (ID) of step d2) is conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C.

In the simplest form, the washing of step d) comprises, in the given order, the steps of:
d1) one wash with a wash solution of aromatic and/or aliphatic hydrocarbon, preferably selected from toluene, hexane or pentane, and optionally internal electron donor (ID),
d2) one wash with a wash solution of titanium tetrachloride and internal electron donor (ID), and
d3) one or more washes with a wash solution of aromatic and/or aliphatic hydrocarbon, preferably selected from toluene, hexane or pentane.

It is, however, preferred that the wash solution of step d1) is a wash solution of internal electron donor (ID) and aromatic and/or aliphatic hydrocarbon, preferably selected from toluene, hexane or pentane, such that step d) comprises, in the given order:
d1) one or more washes with a wash solution of internal electron donor (ID) and aromatic and/or aliphatic hydrocarbon, preferably selected from toluene, hexane or pentane,
d2) one or more washes with a wash solution of titanium tetrachloride and internal electron donor (ID), and
d3) one or more washes with a wash solution of aromatic and/or aliphatic hydrocarbon, preferably selected from toluene, hexane or pentane.

It is likewise preferred that step d2) involves two or more washes with a wash solution of titanium tetrachloride and internal electron donor (ID), such that the washing of step d) comprises, in the given order:
d1) one or more washes with a wash solution of aromatic and/or aliphatic hydrocarbon, preferably selected from toluene, hexane or pentane, and optionally internal electron donor (ID),
d2) two or more washes with a wash solution of titanium tetrachloride and internal electron donor (ID), and
d3) one or more washes with a wash solution of aromatic and/or aliphatic hydrocarbon, preferably selected from toluene, hexane or pentane.

It is further preferred that the wash solution of step d1) is a wash solution of internal electron donor (ID) and aromatic and/or aliphatic hydrocarbon, preferably selected from toluene, hexane or pentane, and that step d2) involves two or more washes with a wash solution of titanium tetrachloride and internal electron donor (ID), such that the washing of step d) comprises, in the given order:
d1) one or more washes with a wash solution of internal electron donor (ID) and aromatic and/or aliphatic hydrocarbon, preferably selected from toluene, hexane or pentane,
d2) two or more washes with a wash solution of titanium tetrachloride and internal electron donor (ID), and
d3) one or more washes with a wash solution of aromatic and/or aliphatic hydrocarbon, preferably selected from toluene, hexane or pentane.

In such embodiments, it is preferred that at least two of the two or more washes with a wash solution of titanium tetrachloride and internal electron donor (ID) of step d2) are conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C.

In a further preferred embodiment, all of the washes with a wash solution of titanium tetrachloride and internal electron donor (ID) of step d2) are conducted at a temperature in the range from 80 to 120° C., more preferably in the range from 85 to 120° C., vet more preferably in the range from 85 to 115° C., still more preferably in the range from 90 to 110° C., most preferably in the range from 95 to 105° C. This requirement may apply equally to embodiments wherein one or more washes with a wash solution of titanium tetrachloride and internal electron donor (ID) of step d2) are present, or indeed wherein two or more washes with a wash solution of titanium tetrachloride and internal electron donor (ID) of step d2) are present.

It is further preferred that the washing of step d) further comprises a step of:
d4) one or more washes with a wash solution of internal electron donor (ID) and aromatic and/or aliphatic hydrocarbon, preferably selected from toluene, hexane or pentane,
wherein step d4) occurs after step d2) and before step d3).

In such embodiments, the washing of step d) comprises, in the given order, the steps of:
d1) one or more washes with a wash solution of aromatic and/or aliphatic hydrocarbon, preferably selected from toluene, hexane or pentane, and optionally internal electron donor (ID),
d2) one or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane.

It is further preferred that the washing of step d) comprises, in the given order, the steps of:
d1) one or more washes with a wash solution of internal electron donor (ID) and aromatic and/or aliphatic hydrocarbon, preferably selected from toluene, hexane or pentane,
d2) one or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane.

It is alternatively preferred that the washing of step d) comprises, in the given order, the steps of:
d1) one or more washes with a wash solution of aromatic and/or aliphatic hydrocarbon, preferably selected from toluene, hexane or pentane, and optionally internal electron donor,
d2) two or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane.

It is yet further preferred that the washing of step d) comprises, in the given order, the steps of:
d1) one or more washes with a wash solution of internal electron donor (ID) and aromatic and/or aliphatic hydrocarbon, preferably selected from toluene, hexane or pentane,
d2) two or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane.

It is especially preferred that the washing of step d) comprises, in the given order, the steps of:
d1) one or more washes with a wash solution of aromatic and/or aliphatic hydrocarbon, preferably selected from toluene, hexane or pentane, and optionally internal electron donor (ID),
d2) two or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane,
wherein all of the washes with a wash solution of titanium tetrachloride and internal electron donor (ID) of step d2) are conducted at a temperature in the range from 80 to 120° C., more preferably in the range from 85 to 120° C., yet more preferably in the range from 85 to 120° C., still more preferably in the range from 90 to 110° C., most preferably in the range from 95 to 105° C.

It is yet further preferred that the washing of step d) comprises, in the given order, the steps of:
d1) one or more washes with a wash solution of internal electron donor (ID) and aromatic and/or aliphatic hydrocarbon, preferably selected from toluene, hexane or pentane,
d2) two or more washes with a wash solution of titanium tetrachloride and internal electron donor (ID),
d4) one or more washes with a wash solution of internal electron donor (ID) and aromatic and/or aliphatic hydrocarbon, preferably selected from toluene, hexane or pentane, and
d3) one or more washes with a wash solution of aromatic and/or aliphatic hydrocarbon, preferably selected from toluene, hexane or pentane,
wherein all of the washes with a wash solution of titanium tetrachloride and internal electron donor (ID) of step d2) are conducted at a temperature in the range from 80 to 120° C., more preferably in the range from 85 to 120° C., yet more preferably in the range from 85 to 120° C., still more preferably in the range from 90 to 110° C., most preferably in the range from 95 to 105° C.

It is particularly preferred that the solvent employed in step dl) and optional step d4) is toluene.

Thus, the washing of step d) preferably comprises, in the given order, the steps of:
d1) one or more washes with a wash solution of toluene and optionally internal electron donor (ID),
d2) one or more washes with a wash solution of titanium tetrachloride and internal electron donor (ID),
d4) optionally, one or more washes with a wash solution of internal electron donor (ID) and toluene, and
d3) one or more washes with a wash solution of aromatic and/or aliphatic hydrocarbon, preferably selected from toluene, hexane or pentane,

More preferably, the washing of step d) comprises, in the given order, the steps of:
d1) one or more washes with a wash solution of internal electron donor (ID) and toluene,
d2) one or more washes with a wash solution of titanium tetrachloride and internal electron donor (ID),
d4) optionally, one or more washes with a wash solution of internal electron donor (ID) and toluene, and
d3) one or more washes with a wash solution of aromatic and/or aliphatic hydrocarbon, preferably selected from toluene, hexane or pentane,

It is particularly preferred that the washing of step d) comprises, in the given order, the steps of:
d1) one or more washes with a wash solution of internal electron donor (ID) and toluene,
d2) two or more washes with a wash solution of titanium tetrachloride and internal electron donor (ID),
d4) one or more washes with a wash solution of toluene and optionally internal electron donor (ID), and
d3) one or more washes with a wash solution of aromatic and/or aliphatic hydrocarbon, preferably selected from toluene, hexane or pentane,
wherein all of the washes with a wash solution of titanium tetrachloride and internal electron donor (ID) of step d2) are conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C.

It is particularly preferred that the washing of step d) comprises, in the given order, the steps of:
d1) one or more washes with a wash solution of internal electron donor (ID) and toluene,
d2) two or more washes with a wash solution of titanium tetrachloride and internal electron donor (ID),
d4) one or more washes with a wash solution of internal electron donor (ID) and toluene, and
d3) one or more washes with a wash solution of aromatic and/or aliphatic hydrocarbon, preferably selected from toluene, hexane or pentane,
wherein all of the washes with a wash solution of titanium tetrachloride and internal electron donor (ID) of step d2) are conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C.

In each of these embodiments in which step d) further comprises step d4), the amount of donor present in the wash solution of internal electron donor (ID) and aromatic and/or aliphatic hydrocarbon, preferably selected from toluene, hexane or pentane, is such that the molar ratio between the said amount of internal electron donor (ID) to the amount of magnesium in the Ziegler-Natta catalyst component ([ID] /[Mg]) is in the range from 0.01 to 0.20, more preferably in the range from 0.02 to 0.15, most preferably in the range from 0.03 to 0.10.

The amount of magnesium in the Ziegler-Natta catalyst is assumed to be equal to the amount of magnesium used in the preceding catalyst preparation steps that introduce magnesium, i.e. all magnesium used in the catalyst preparation may be assumed to end up in the Ziegler-Natta catalyst.

Without being bound by theory, it is believed that the higher the temperature in the one or more washes with a wash solution of titanium tetrachloride and internal electron donor (ID) of step d2), the more donor will need to be present in step d4).

In each of the aforementioned embodiments, the internal donor (ID) employed in steps d1) (if donor is present), d2), d4) (if the step is present) and at any step prior to step c) is a non-phthalic internal donor.

The non-phthalic internal donor used in these steps may be the same or different, or may be a mixture of non-phthalic internal donors.

In one preferred embodiment, the non-phthalic internal donor in each of steps dl) (if donor is present), d2), d4) (if the step is present) and at any step prior to step c) is the same non-phthalic internal donor, being either a single non-phthalic internal donor or a mixture of non-phthalic internal donors, most preferably a single non-phthalic internal donor.

It is particularly preferred that the non-phthalic internal electron donor is a non-phthalic diester, or a mixture of non-phtalic diesters, most preferably is a single non-phthalic diester.

It is further preferred that the non-phthalic internal electron donor is a mono-unsaturated diester, or a mixture of mono-unsaturated diesters, most preferably is a single mono-unsaturated diester.

In particular, the non-phthalic intemal electron donor is preferably selected from the group of maleates, citraconates, cyclohexene-1,2-dicarboxylates and any derivatives and/or mixtures thereof.

Most preferably, the non-phthalic electron donor is a citraconate internal electron donor.

The magnesium component of step a) may be any magnesium-containing compound, but preferably is selected from magnesium halides, magnesium alkoxides and mixtures thereof.

In one particularly preferred embodiment, the magnesium component is a magnesium alkoxide.

Step a), in which the solution of at least one magnesium component is provided can be carried out according to any known method for providing a solution of at least one magnesium component known in the art.

Suitable methods include methods al) to a5):
a1) providing a solution of at least a magnesium alkoxy compound (Ax) being the reaction product of a magnesium compound (MgC) and a monohydric alcohol (A) comprising in addition to the hydroxyl moiety at least one ether moiety optionally in an organic liquid reaction medium: or
a2) a solution of at least a magnesium alkoxy compound (Ax′) being the reaction product of a magnesium compound (MgC) and an alcohol mixture of the monohydric alcohol (A) and a monohydric alcohol (B) of formula ROH, wherein R is a linear or branched alkyl groups of 2 to 16 carbon atoms, optionally in an organic liquid reaction medium; or
a3) providing a solution of a mixture of the magnesium alkoxy compound (Ax) and a magnesium alkoxy compound (Bx) being the reaction product of a magnesium compound (MgC) and the monohydric alcohol (B), optionally in an organic liquid reaction medium; or
a4) providing a solution of a magnesium alkoxy compound of formula Mg(OR¹)ₙ(OR²) mX2-n-m or a mixture of magnesium alkoxides Mg(OR¹) _{′}X_{2-n′} and Mg(OR²) m′X2-m′, where X is halogen, R¹ and R² are different linear or branched alkyl groups of 2 to 16 carbon atoms, and 0≤n<2, 0≤m<2 and 0<n+m≤2, whilst 0<n′≤2 and 0<m′≤2;
a5) providing a solution comprising Mg dihalide in an alcohol mixture comprising at least a monohydric alcohol (A1) of formula ROH, where R is selected from hydrocarbyl of 3 to 16 C atoms (and optionally an alcohol (A2) comprising in addition to the hydroxyl group another oxygen containing functional group not being a hydroxyl group):
a6) providing a solution comprising Mg dihalide in an organic solvent.

In one preferred embodiment, step a) consists of:
a1) providing a solution of at least a magnesium alkoxy compound (Ax) being the reaction product of a magnesium compound (MgC) and a monohydric alcohol (A) comprising in addition to the hydroxyl moiety at least one ether moiety optionally in an organic liquid reaction medium; or
a2) a solution of at least a magnesium alkoxy compound (Ax') being the reaction product of a magnesium compound (MgC) and an alcohol mixture of the monohydric alcohol (A) and a monohydric alcohol (B) of formula ROH, wherein R is a linear or branched alkyl groups of 2 to 16 carbon atoms, optionally in an organic liquid reaction medium: or
a3) providing a solution of a mixture of the magnesium alkoxy compound (Ax) and a magnesium alkoxy compound (Bx) being the reaction product of a magnesium compound (MgC) and the monohydric alcohol (B), optionally in an organic liquid reaction medium; or
a4) providing a solution of a magnesium alkoxy compound of formula Mg(OR¹)ₙ(OR²)ₘX₂₋ₙ₋ₘ or a mixture of magnesium alkoxides Mg(OR¹)ₙX_{2-n′} and Mg(OR²)_{m′}X_{2-m′}, where X is halogen, R¹and R² are different linear or branched alkyl groups of 2 to 16 carbon atoms, and 0≤n<2, 0<m<2 and 0<n+m≤2, whilst 0<n′≤2 and 0<m′≤2;
a5) providing a solution comprising Mg dihalide in an alcohol mixture comprising at least a monohydric alcohol (A1) of formula ROH, where R is selected from hydrocarbyl of 3 to 16 C atoms (and optionally an alcohol (A2) comprising in addition to the hydroxyl group another oxygen containing functional group not being a hydroxyl group):
a6) providing a solution comprising Mg dihalide in an organic solvent,
wherein additionally a non-phthalic internal electron donor according to the invention may be added at any stage.

The internal donor (ID) or precursor thereof is thus added preferably to the solution of step a) or to the titanium (IV) compound before adding the solution of step a).

According to the procedure above the Ziegler-Natta catalyst component can be obtained via precipitation method or via emulsion-solidification method depending on the physical conditions, especially temperature used in steps b) and c). Emulsion is also called in this application liquid/liquid two-phase system.

In both methods (precipitation or emulsion-solidification) the catalyst chemistry is the same.

In precipitation method combination of the solution of step a) with at least one titanium (IV) compound in step b) is carried out and the whole reaction mixture is kept at least at 50° C., more preferably in the temperature range from 55 to 110° C., more preferably in the range from 70 to 100° C., to secure full precipitation of the catalyst component in form of a solid particles (step c).

In emulsion-solidification method in step b) the solution of step a) is typically added to the at least one titanium (IV) compound at a lower temperature, such as from −10 to below 50° C., preferably from −5 to 30° C. During agitation of the emulsion the temperature is typically kept at −10 to below 40° C., preferably from −5 to 30° C. Droplets of the dispersed phase of the emulsion form the active catalyst composition. Solidification (step c) of the droplets is suitably carried out by heating the emulsion to a temperature of 70 to 150° C., preferably to 80 to 110° C.

The catalyst prepared by emulsion-solidification method is preferably used in the present invention.

In a preferred embodiment in step a) the solution of a2) or a3) are used, i.e. a solution of (Ax′) or a solution of a mixture of (Ax) and (Bx), especially the solution of a2).

The magnesium alkoxy compounds as defined above can be prepared in situ in the first step of the catalyst preparation process, step a), by reacting the magnesium compound with the alcohol(s) as described above, or said magnesium alkoxy compounds can be separately prepared magnesium alkoxy compounds or they can be even commercially available as ready magnesium alkoxy compounds and used as such in the catalyst preparation process of the invention.

Illustrative examples of alcohols (A) are glycol monoethers. Preferred alcohols (A) are C₂ to C₄ glycol monoethers, wherein the ether moieties comprise from 2 to 18 carbon atoms, preferably from 4 to 12 carbon atoms. Preferred examples are 2-(2-ethylhexyloxy) ethanol, 2-butyloxy ethanol, 2-hexyloxy ethanol and 1,3-propylene-glycol-monobutyl ether, 3-butoxy-2-propanol, with 2-(2-ethylhexyloxy) ethanol and 1,3-propylene-glycol-monobutyl ether, 3-butoxy-2-propanol being particularly preferred.

Illustrative monohydric alcohols (B) are of formula ROH, with R being straight-chain or branched C₂-C₁₆ alkyl residue, preferably C₄ to C₁₀, more preferably C6 to C₈ alkyl residue. The most preferred monohydric alcohol is 2-ethyl-1-hexanol or octanol.

Preferably a mixture of Mg alkoxy compounds (Ax) and (Bx) or mixture of alcohols (A) and (B), respectively, are used and employed in a mole ratio of Bx:Ax or B:A from 10:1 to 1:10, more preferably 6:1 to 1:6, most preferably 4.1 to 1:4.

Magnesium alkoxy compound may be a reaction product of alcohol(s), as defined above, and a magnesium compound selected from dialkyl magnesiums, alkyl magnesium alkoxides, magnesium dialkoxides, alkoxy magnesium halides and alkyl magnesium halides. Further, magnesium dialkoxides, magnesium diaryloxides, magnesium aryloxyhalides, magnesium aryloxides and magnesium alkyl aryloxides can be used.Alkyl groups can be a similar or different C₁-C₂₀ alkyl, preferably C₂-C₁₀ alkyl. Typical alkyl-alkoxy magnesium compounds, when used, are ethyl magnesium butoxide, butyl magnesium pentoxide, octyl magnesium butoxide and octyl magnesium octoxide. Preferably the dialkyl magnesiums are used. Most preferred dialkyl magnesiums are butyl octyl magnesium or butyl ethyl magnesium.

It is also possible that magnesium compound can react in addition to the alcohol (A) and alcohol (B) also with a polyhydric alcohol (C) of formula R″ (OH)ₘ to obtain said magnesium alkoxide compounds. Preferred polyhydric alcohols, if used, are alcohols, wherein R″ is a straight-chain, cyclic or branched C₂ to C₁₀ hydrocarbon residue, and m is an integer of 2 to 6.

The magnesium components of step a) are thus selected from the group consisting of magnesium dihalides, magnesium dialkoxides, diaryloxy magnesiums, alkyloxy magnesium halides, aryloxy magnesium halides, alkyl magnesium alkoxides, aryl magnesium alkoxides and alkyl magnesium aryloxides. In addition a mixture of magnesium dihalide and a magnesium dialkoxide can be used.

The solvents to be employed for the preparation of the present catalyst may be selected among aromatic and aliphatic straight chain, branched and cyclic hydrocarbons with 5 to 20 carbon atoms, more preferably 5 to 12 carbon atoms, or mixtures thereof. Suitable solvents include benzene, toluene, cumene, xylene, pentane, hexane, heptane, octane and nonane. Heptanes, hexanes and pentanes are particular preferred.

The reaction for the preparation of the magnesium component may be carried out at a temperature of 40 to 70° C. Most suitable temperature is selected depending on the Mg compound and alcohol(s) used.

The titanium (IV) compound is most preferably a titanium (IV) halide, like TiCl₄.

In emulsion method, the two phase liquid-liquid system may be formed by simple stirring and optionally adding (further) solvent(s) and additives, such as the turbulence minimizing agent (TMA) and/or the emulsifying agents and/or emulsion stabilizers, like surfactants, which are used in a manner known in the art for facilitating the formation of and/or stabilize the emulsion. Preferably, surfactants are acrylic or methacrylic polymers. Particular preferred are unbranched C₁₂ to C₂₀ (meth) acrylates such as poly (hexadecyl)-methacrylate and poly (octadecyl)-methacrylate and mixtures thereof. Turbulence minimizing agent (TMA), if used, is preferably selected from α-olefin polymers of α-olefin monomers with 6 to 20 carbon atoms, like polyoctene, polynonene, polydecene, polyundecene or polydodecene or mixtures thereof. Most preferable it is polydecene.

The solid particulate product obtained by precipitation or emulsion—solidification method is washed according to the washing step d), described above and below.

Aluminium compounds can also be added during the catalyst synthesis. The catalyst can further be dried, as by evaporation or flushing with nitrogen or it can be slurried to an oily liquid without any drying step.

In some embodiments, following step e), the Ziegler-Natta catalyst component is further modified by a polymeric nucleating agent obtained by polymerizing a vinyl monomer of formula (I):

H₂C═CH—CHR¹R² (I),

wherein R¹ and R² independently represent a lower alkyl group containing 1 to 4 carbon atoms or, together with the carbon atom they are attached to, form an optionally substituted saturated, unsaturated or aromatic ring or a fused ring system, wherein the ring or fused ring moiety contains four to 20 carbon atoms, preferably R¹ and R², together with the carbon atom they are attached to, form a 5 to 12 membered saturated or unsaturated or aromatic ring or a fused ring system.

Preferably R¹ and R², together with the C-atom wherein they are attached to, form a five-or six-membered saturated or unsaturated or aromatic ring or independently represent a lower alkyl group comprising from 1 to 4 carbon atoms.

Preferred vinyl compounds for the preparation of a polymeric nucleating agent to be used in accordance with the present invention are in particular vinyl cycloalkanes, in particular vinyl cyclohexane (VCH), vinyl cyclopentane, and vinyl-2-methyl cyclohexane, 3-methyl-1-butene, 3-ethyl-1-hexene, 3-methyl-1-pentene, 4-methyl-1-pentene or mixtures thereof. VCH is a particularly preferred monomer.

The polymeric nucleating agent is preferably incorporated in the catalyst component by the so called BNT-technology as mentioned below.

With regard to the BNT-technology reference is made to the international applications WO 99/24478, WO 99/24479 and particularly WO 00/68315. According to this technology the catalyst component is modified by polymerizing a vinyl compound in the presence of the catalyst system, comprising in particular the special catalyst component, an external donor and a cocatalyst

General conditions for the modification of the catalyst, like liquid media and process parameters are also disclosed in WO 99/24478, WO 99/24479 and particularly WO 00/68315, incorporated herein by reference with respect to the modification of the polymerization catalyst.

The weight ratio of vinyl compound to polymerization catalyst in the modification step of the polymerization catalyst preferably is 0.3 or more up to 40, such as 0.4 to 20 or more preferably 0.5 to 15, like 0.5 to 2.0.

Suitable media for the modification step include, in addition to oils, also aliphatic inert organic solvents with low viscosity, such as pentane and heptane. Furthermore, small amounts of hydrogen can be used during the modification.

The polymeric nucleating agent usually is present in the final product in an amount of from more than 10 ppm, typically more than 15 ppm, (based on the weight of the polypropylene composition). Preferably, this agent is present in the polypropylene composition in a range from 10 to 1000 ppm, more preferably more than 15 to 500 ppm, such as 20 to 100 ppm.

The polymerization of the catalyst with said vinyl compound is performed until the concentration of unreacted vinyl compound is less than about 0.5 wt.-%, preferably less than 0.1 wt.-%.

This polymerization step is usually done in the pre-polymerization step prior to the polymerization process used for producing a polyolefin, preferably polypropylene.

### Ziegler-Natta Catalyst Composition

The present invention is further directed to a Ziegler-Natta catalyst composition that is obtainable by the catalyst preparation process as described above.

If the Ziegler-Natta catalyst component obtained in step e) is further modified by a polymeric nucleating agent obtained by polymerizing a vinyl monomer of formula (I), then the Ziegler-Natta catalyst composition comprises, more preferably consists of, this modified catalyst component.

If no further modification takes place, then the Ziegler-Natta catalyst composition comprises, more preferably consists of, the Ziegler-Natta catalyst component as described above and below.

In particular, it is preferred that the titanium content of the Ziegler-Natta catalyst component, more preferably of the Ziegler-Natta catalyst composition, is in the range from 1.00 to 2.40 wt.-%, more preferably in the range from 1.30 to 2.20 wt.-%, most preferably in the range from 1.50 to 2.00 wt.-%.

Furthermore, it is preferred that the weight ratio of titanium to magnesium ([Ti]/[Mg]) in said Ziegler-Natta catalyst component, more preferably of the Ziegler-Natta catalyst composition, is in the range from 0.06 to 0.14, more preferably in the range from 0.07 to 0.13, most preferably in the range from 0.08 to 0.12.

It is also preferred that the magnesium content of the Ziegler-Natta catalyst component, more preferably of the Ziegler-Natta catalyst composition, is in the range from 11.0 to 24.0 wt.-%, more preferably in the range from 14.0 to 22.0 wt.-%, most preferably in the range from 17.0 to 20.0 wt.-%.

It is further preferred that the internal donor content of the Ziegler-Natta catalyst component, more preferably of the Ziegler-Natta catalyst composition, is in the range from 10.0 to 23.0 wt.-%, more preferably in the range from 13.0 to 20.0 wt.-%, most preferably in the range from 15.0 to 18.0 wt.-%.

It is preferred that the weight ratio of titanium to internal donor ([Ti]/[ID]) in said Ziegler-Natta catalyst component, more preferably of the Ziegler-Natta catalyst composition, is in the range from 0.06 to 0.13, more preferably in the range from 0.07 to 0.12, most preferably in the range from 0.08 to 0.11.

It is also preferred that the weight ratio of magnesium to internal donor ([Mg]/[ID]) in said Ziegler-Natta catalyst component, more preferably of the Ziegler-Natta catalyst composition, is in the range from 1.00 to 1.50, more preferably in the range from 1.00 to 1.35, most preferably in the range from 1.05 to 1.20.

The Ziegler-Natta catalyst component, more preferably the Ziegler-Natta catalyst composition, is desirably in the form of particles having generally an average particle size range of 5 to 200 μm, preferably 10 to 100. Particles are compact with low porosity and have surface area below 20 g/m², more preferably below 10 g/m².

Detailed description of preparation of catalysts is disclosed in WO 2012/007430, EP2610271, EP 2610270 and EP2610272.

All preferable embodiments and fallback ranges expressed in the sections above and below apply mutatis mutandis to the Ziegler-Natta catalyst component and/or Ziegler-Natta catalyst composition.

### Polymerization Process

The present invention is also directed to a process for the production of a polypropylene composition using the inventive catalyst and to the use of such a catalyst for such a process.

In one embodiment, the present invention is directed to a process for the production of a polypropylene composition, comprising the polymerization of propylene, optionally with comonomers selected from C2 or C4 to C12 alpha olefins in the presence of a Ziegler-Natta catalyst system comprising a Ziegler Natta catalyst composition according to the present invention, a co-catalyst (Co) and optionally an external donor (ED).

In an alternative embodiment, the present invention is directed to a process for the production of a polypropylene composition, said process comprising, in the given order, the steps of:
a) providing a solution of at least one magnesium component,
b) adding said solution from step a) to a titanium (IV) compound, obtaining thereby solid catalyst component particles,
c) recovering said solid catalyst component particles from the solution resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, preferably selected from toluene, hexane or pentane, and optionally internal electron donor (ID),
d2) one or more washes with a wash solution of titanium tetrachloride and internal electron donor (ID), and
d3) one or more washes with a wash solution of aromatic and/or aliphatic hydrocarbon, preferably selected from toluene, hexane or pentane,
wherein at least one of the one or more washes with a wash solution of titanium tetrachloride and internal electron donor (ID) of step d2) is conducted at a temperature in the range from 80 to 120° C., more preferably in the range from 85 to 120° C., yet more preferably in the range from 85 to 115° C., still more preferably in the range from 90 to 110° C., most preferably in the range from 95 to 105° C., and
polymerizing propylene, optionally with comonomers selected from C2 or C4 to C12 alpha olefins in the presence of a Ziegler-Natta catalyst system comprising a Ziegler Natta catalyst composition comprising the solid catalyst component recovered in step e), a co-catalyst (Co) and optionally an external donor (ED).

The present invention is furthermore directed to a use of the Ziegler-Natta catalyst composition according to the present invention, together with a co-catalyst (Co) and an optional external donor (ED), for the polymerization of propylene, optionally with comonomers selected from C2 or C4 to C12 alpha olefins

Suitable external donors (ED) include certain silanes, ethers, esters, amines, ketones, heterocyclic compounds and blends of these. It is especially preferred to use a silane. It is most preferred to use silanes of the general formula

R^{a}ₚR^{b}_{q}Si(OR^{c})_{(4-p-q)}

wherein R^{a}, R^{b} and R^{c} denote a hydrocarbon radical, in particular an alkyl or cycloalkyl group, and wherein p and q are numbers ranging from 0 to 3 with their sum p+q being equal to or less than 3. R^{a}, R^{b} and R^{c} can be chosen independently from one another and can be the same or different. Specific examples of such silanes are (tert-butyl) 2Si(OCH3)₂, (cyclohexyl)(methyl) Si(OCH₃)², (phenyl)₂Si(OCH₃)₂ and (cyclopentyl)₂Si(OCH₃)₂, or of general formula

Si(OCH₂CH₃)₃(NR³R⁴)

wherein R³ and R⁴ can be the same or different a represent a hydrocarbon group having 1 to 12 carbon atoms.

R³ and R+are independently selected from the group consisting of linear aliphatic hydrocarbon group having 1 to 12 carbon atoms, branched aliphatic hydrocarbon group having 1 to 12 carbon atoms and cyclic aliphatic hydrocarbon group having 1 to 12 carbon atoms. It is in particular preferred that R³ and R⁴ are independently selected from the group consisting of methyl, ethyl, n-propyl, n-butyl, octyl, decanyl, iso-propyl, iso-butyl, iso-pentyl, tert.-butyl, tert.-amyl, neopentyl, cyclopentyl, cyclohexyl, methylcyclopentyl and cycloheptyl.

More preferably both R¹ and R² are the same, yet more preferably both R³ and R⁴ are an ethyl group.

Especially preferred external donors (ED) are the di-cyclopentyl-dimethoxy silane donor (D-donor) or the cyclohexylmethyl dimethoxy silane donor (C-Donor).

In addition to the Ziegler-Natta catalyst composition and the optional external donor (ED) a co-catalyst should be used. The co-catalyst is preferably a compound of group 13 of the periodic table (IUPAC), e.g. organo aluminum, such as an aluminum compound, like aluminum alkyl, aluminum halide or aluminum alkyl halide compound. Accordingly, in one specific embodiment the co-catalyst (Co) is a trialkylaluminium, like triethylaluminium (TEAI), dialkyl aluminium chloride or alkyl aluminium dichloride or mixtures thereof. In one specific embodiment the co-catalyst (Co) is triethylaluminium (TEAI).

Advantageously, the triethyl aluminium (TEAl) has a hydride content, expressed as AlH₃, of less than 1.0 wt.-% with respect to the triethyl aluminium (TEAI). More preferably, the hydride content is less than 0.5 wt.-%, and most preferably the hydride content is less than 0.1 wt.-%.

Preferably the ratio between the co-catalyst (Co) and the external donor (ED) [Co/ED] and/or the ratio between the co-catalyst (Co) and the titanium [Co/Ti] should be carefully chosen.

Accordingly,
(a) the mol-ratio of co-catalyst (Co) to external donor (ED) [Co/ED] must be in the range of 5 to 45, preferably is in the range of 5 to 35, more preferably is in the range of 5 to 25; and optionally
(b) the mol-ratio of co-catalyst (Co) to titanium [Co/Ti] must be in the range of above 70 to 500, preferably is in the range of 80 to 300, still more preferably is in the range of 90 to 200.

The polymerization process for the production of the polypropylene may be a continuous process or a batch process utilising known methods and operating in liquid phase, optionally in the presence of an inert diluent, or in gas phase or by mixed liquid-gas techniques.

The polymerization process may be a single-or multistage polymerization process such as gas phase polymerization, slurry polymerization, solution polymerization or combinations thereof.

For the purpose of the present invention, “slurry reactor” designates any reactor, such as a continuous or simple batch stirred tank reactor or loop reactor, operating in bulk or slurry and in which the polymer forms in particulate form. “Bulk” means a polymerization in reaction medium that comprises at least 60 wt.-% monomer. According to a preferred embodiment the slurry reactor comprises a bulk loop reactor. By “gas phase reactor” is meant any mechanically mixed or fluid bed reactor. Preferably the gas phase reactor comprises a mechanically agitated fluid bed reactor with gas velocities of at least 0.2 m/sec.

The polypropylene can be made e.g. in one or two slurry bulk reactors, preferably in one or two loop reactor(s), or in a combination of one or two loop reactor(s) and at least one gas phase reactor. Those processes are well known to one skilled in the art.

Preferably the reactors used are selected from the group of loop and gas phase reactors and, in particular, the process employs at least one loop reactor and at least one gas phase reactor.

It is also possible to use several reactors of each type. e.g. one loop reactor and two or three gas phase reactors, or two loops and one gas phase reactor in series.

If polymerization is performed in one or two loop reactors, the polymerization is preferably carried out in liquid propylene mixtures at temperatures in the range from 20 to 100° C.

Preferably, temperatures are in the range from 60 to 80° C. The pressure is preferably between 5 and 60 bar. Possible comonomers can be fed to any of the reactors. The molecular weight of the polymer chains and thereby the melt flow rate of the polypropylene, is regulated by adding hydrogen.

The gas phase reactor can be an ordinary fluidized bed reactor, although other types of gas phase reactors can be used. In a fluidized bed reactor, the bed consists of the formed and growing polymer particles as well as still active catalyst come along with the polymer fraction. The bed is kept in a fluidized state by introducing gaseous components, for instance monomer on such flowing rate which will make the particles act as a fluid. The fluidizing gas can contain also inert carrier gases, like nitrogen and also hydrogen as a modifier. The fluidized gas phase reactor can be equipped with a mechanical mixer.

The gas phase reactor used can be operated in the temperature range of 50 to 110° C., preferably between 60 and 90° C. and a reaction pressure between 5 and 40 bar.

Suitable processes are disclosed, among others, in WO-A-98/58976, EP-A-887380 and WO-A-98/58977.

In every polymerization step it is possible to use also comonomers selected from the group of ethylene, 1-butene, 1-pentene, 1-hexene, 1-octene and alike as well as their mixtures.

In addition to the actual polymerization reactors used for producing the propylene homo or copolymers the polymerization configuration can also include a number of additional reactors, such as pre-and/or postreactors. The prereactors include any reactor for prepolymerizing the modified catalyst with propylene and/or ethylene or other 1-olefin, if necessary.

The postreactors include reactors used for modifying and improving the properties of the polymer product (cf. below). All reactors of the reactor system are preferably arranged in series.

If desired, the polymerization product can be fed into a gas phase reactor in which a rubbery copolymer is provided by a (co)polymerization reaction to produce a modified polymerization product. This polymerization reaction will give the polymerization product properties of e.g. improved impact strength. The step of providing an elastomer can be performed in various ways. Thus, preferably an elastomer is produced by copolymerizing at least propylene and ethylene into an elastomer.

The present polymerization product from the reactor(s), so called reactor powder in the form of polypropylene powder, fluff, spheres etc., is normally melt blended, compounded and pelletised with adjutants such as additives, fillers and reinforcing agents conventionally used in the art and/or with other polymers. Thus, suitable additives include antioxidants, acid scavengers, antistatic agents, flame retardants, light and heat stabilizers, lubricants, optionally additional nucleating agents, clarifying agents, pigments and other colouring agents including carbon black. Fillers, such as talc, mica and wollastonite can also be used.

### EXAMPLES

### 1. Definitions/Measuring Methods

The following definitions of terms and determination methods apply for the above general description of the invention as well as to the below examples unless otherwise defined.

MFR₂ (230° C.) was measured according to ISO 1133 (230° C., 2.16 kg load).

The xylene solubles (XCS, wt.-%): Content of xylene cold solubles (XCS) was determined at 25° C. according ISO 16152; first edition; 2005 Jul. 1

Melting temperature (Tₘ): measured via DSC analysis with a TA Instrument Q2000 differential scanning calorimetry (DSC) on 5 to 7 mg samples. DSC was run according to ISO 11357/part 3/method C2 in a heat/cool/heat cycle with a scan rate of 10° C./min in the temperature range from −30 to +225° C. Crystallization temperature and heat of crystallization (Hc) are determined from the cooling step, while melting temperature and heat of fusion (Hr) are determined from the second heating step (although only melting temperature is given in the relevant for the following examples.

Molecular weight distribution-GPC: Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined by Gel Permeation Chromatography (GPC) according to ISO 16014-1:2003, ISO 16014-2:2003, ISO 16014-4:2003 and ASTM D 6474-12 using the following formulas:

$${M}_{n} = \frac{{\sum }_{i = 1}^{N} {A}_{i}}{{\sum }_{i = 1}^{N} ( {A}_{i} / {M}_{i} )} \qquad ( 1 )$$

$${M}_{w} = \frac{{\sum }_{i = 1}^{N} ( {A}_{i} \times {M}_{i} )}{{\sum }_{i = 1}^{N} {A}_{i}} \qquad ( 2 )$$

$${M}_{z} = \frac{{\sum }_{i = 1}^{N} ( {A}_{i} \times {M}_{i}^{2} )}{{\sum }_{i = 1}^{N} ( {A}_{i} \times {M}_{i} )} \qquad ( 3 )$$

For a constant elution volume interval ΔVᵢ, where Aᵢ, and Mᵢ are the chromatographic peak slice area and polyolefin molecular weight (MW), respectively associated with the elution volume, Vᵢ, where N is equal to the number of data points obtained from the chromatogram between the integration limits.

A high temperature GPC instrument, equipped with either infrared (IR) detector (IR4 or IR5 from PolymerChar (Valencia, Spain), equipped with 3 × Agilent-PLgel Olexis and 1×

Agilent-PLgel Olexis Guard columns was used. As the solvent and mobile phase 1,2,4-trichlorobenzene (TCB) stabilized with 250 mg/L 2,6-Di tert butyl-4-methyl-phenol) was used. The chromatographic system was operated at 160° C. and at a constant flow rate of 1mL/min. 200 μL of sample solution was injected per analysis. Data collection was performed using either Agilent Cirrus software version 3.3 or PolymerChar GPC-IR control software.

The column set was calibrated using universal calibration (according to ISO 16014-2:2003) with 19 narrow MWD polystyrene (PS) standards in the range of 0.5 kg/mol to 11 500 kg/mol. The PS standards were dissolved at room temperature over several hours. The conversion of the polystyrene peak molecular weight to polyolefin molecular weights is accomplished by using the Mark Houwink equation and the following Mark Houwink constants:

$${K}_{PS} = 19 \times {10}^{- 3} mL / g , \qquad {α}_{PS} = 0.655$$

$${K}_{P E} = 39 \times {10}^{- 3} mL / g , \qquad {α}_{P E} = 0 \text{.725}$$

$${K}_{P P} = 19 \times {10}^{- 3} mL / g , \qquad {α}_{P P} = 0.725$$

A third order polynomial fit was used to fit the calibration data.

All samples were prepared in the concentration range of 0.5-1 mg/ml and dissolved at 160° C. for 2.5 hours for PP or 3 hours for PE under continuous gentle shaking.

### Scanning Electron Microscopy—SEM

Scanning Electron Microscopy (SEM) was performed using FEI Quanta 200 FEG microscope. The catalyst particles were attached on sample holder with carbon or copper conductive adhesive. If necessary, part of the catalyst particles were cut using microtome blade. The samples were sputter coated with Au/Pd in Agar Auto sputter coater. Images are typically acquired with settings of 1.5-3 kV acceleration voltage, high-vacuum mode, working distance 10 mm, 3.0 spot size and using Everhart-Thornley detector (ETD). Images were collected with 1024×884 pixels2 at magnifications in the range of 60×-6000×.

### Polymer Imaging with Light Microscopy

### Instrument: Leica MZ16

Description: Sample is mixed well with a spoon in plastic bag. Approx. 5 mL aliquot is taken for imaging. Sample is placed on black matte paper in petri dish. Images are taken with various magnification factors (0.71, 1.0, 1.25, 1.6, 2.0, 2.5, 3.2, 4.0, 5.0, and 6.3).

### Catalyst Imaging with Light Microscope

### Instrument: Polyvar Microscope

Description: Oil slurry sample is mixed well using carousel mixer for about 30 mins. About 0.5 ml aliquot is taken with 2 mm needle into 3 ml syringe and diluted with approximate 1 ml of clean oil. Sample is mixed in the syringe by tilting it over several times. Two drops of diluted sample is placed on microscopy glass and cover slips are placed on top avoiding air bubbles in between the glass plates.

Several images are taken with 4×, 10× and 25× objectives

ZNPP—ID, 2-EHA, PGBE and HC content—GC-FID: A portion of 60-90 mg of dry catalyst sampled inertly in crimp-cap glass vial is dissolved and extracted by mixture of 5 mL of dichloromethane and 1.0 mL of solution of internal standard (0.71%, V/V) in distilled and deionized water. After sonicating the mixture for 30 minutes to ensure full dissolution, the phases are let to settle and the organic phase is sampled and filtered using 0.45 μm syringe filter to instrument vial. GC analysis was carried out using Agilent 7890B Gas Chromatogram system equipped with flame ionisation detector. The column used was a ZB-5HT Inferno 15 m×320 μm×0.25 μm with a pre-column restriction capillary of 1.5 m×320 μm×0 μm. The initial oven temperature is set to 40° C. for 3 minutes before the ramp program consisting of first ramp at 5° C./min to 70° C., second ramp at 40° C./min to 330° C. and third ramp of 20° C./min to 350° C. with a hold time of 1 min. The injection volume was 1 μL with split ratio of 1:20. The carrier gas was 99.995% He. The inlet and FID were operated at 280° C. and 370° C., respectively. Signal from FID in chromatogram was integrated and calculated against a series of standardisation samples, using the response ratios between the signal for the analyte and the internal standard. Two parallel measurements were performed from each sample and the internal donor content was reported as the mean of the two replicates.

ZNPP—Al, Ti and Mg content—ICP OES: A test portion of 20-50 mg of dry ZN catalyst was inertly sampled in a crimp cap glass vial. Volume of 5 mL of HNO3 (65%) and distilled and deionized water were added into the sample vial and the mixture was stirred until the catalyst had fully dissolved. Sample solution was transferred into 100 mL volumetric flask and filled to mark with distilled and deionized water.

The elemental analysis was performed using Thermo Scientific Inductively Coupled Plasma—Optical Emission Spectrometer (ICP-OES) iCAP 6300 Radial. The instrument was calibrated for Al, Ti and Mg using a blank (a solution of 5% HNO3), and 5 standards of 0.5, 1, 10, 50, and 100 mg/L of Al, Ti and Mg in solutions of 5% HNO3 in deionised water. The content of Mg is monitored using the 285.213 nm and the content for Ti using 336.121 nm line. The content of Al is monitored via the 167.079 nm line, when Al concentration in test portion is between 0-10 wt % and via the 396.152 nm line for Al concentrations above 10 wt %. The reported values are an average of three successive aliquots taken from the same sample and are related back to the original catalyst sample by inputting the original mass of test portion and the dilution volume into the software.

### Particle Size Distribution—Malvern PSD Analysis

### ZNPP—Particle Size Distribution—Automated Image Analysis.

A test solution is prepared by adding white mineral oil to inertly sampled test portion of ZN catalyst powder so that the final mixture holds a concentration of approx. 0.5-0.7 wt.-%. The test solution is carefully mixed before taking a portion that is placed in a measuring cell suitable for the instrument.

The automated image analysis was performed using Malvern Morphologi 3G system. The measuring cell is placed on a microscopy stage. Diascopic light source is used and the illumination intensity and focus level is adjusted before each run. Partially overlapping microscopy image frames were recorded by a CCD camera and images stored on a system specific software via a microscope that has an objective sufficient working distance and a magnification of 5x. The collected images are analysed by the software where the particles are individually identified by comparison to the background using a material predefined greyscale setting. A classification scheme is applied to the individually identified particles to include only images of sample material particles in the analysis.

The particle diameter is calculated as the circular equivalent (CE) diameter. The size range for particles included in the distribution is 6.5-420 μm. The distribution is calculated as a numerical moment-ratio density function distribution and statistical descriptors calculated based on the numerical distribution. The numerical distribution can for each bin size be recalculated for an estimate of the volume transformed distribution.

All graphical representations are based on a smothering function based on 11 points and the statistical descriptors of the population are based on the unsmothered curve. The particle size distribution is reported using statistical descriptors, where d90 indicates the particle diameter at 90% cumulative size, d10 indicates the particle diameter at 10% cumulative size, and d50 indicates the particle diameter at 50% cumulative size. The mode is determined manually as the peak of the smothered frequency curve. Span is calculated as the (CE D [x,0.9]-CE D [x,0.1])/CE D [x,0.5].

### Chemicals Used in the Examples

2-ethyl-hexanol-CAS no 104-76-7
propylene glycol butyl mono ether—CAS no 5131-66-8, provided by Sigma-Aldrich
bis(2-ethylhexyl) citraconate—CAS no 1354569-12-2
Viscoplex 1-254—provided by RohMax Additives GmbH
Triethyl aluminum (TEAI) as 0.62 M solution in n-heptane was acquired from Chemtura and used “as is”
Dicyclopentyl dimethoxy silane (donor D)—CAS number 126990-35-0, was acquired from Wacker at 99.0% purity and diluted with n-heptane to prepare a 0.3 M solution. MEHO+ is a mixture of magnesium compounds (magnesium bis(2-ethylhexoxide) and magnesium bis(1-butoxypropan-2-olate) mixture, 33% in n-heptane/toluene (8:2 weight ratio)) with Mg-content of 3.2 wt.-% and was acquired from Albemarle and used “as is”.

### 2. Experiments

### a) Catalyst Preparation

### Inventive Example 1

16.1 kg of MEHO+ (33 wt.-% in n-heptane/toluene) was added to a 90 L reactor equipped with a mechanical stirrer at 14° C. 0.15 kg of Viscoplex 1-254 was added under mixing (200 rpm) and subsequently stirred for 120 minutes before 2.9 kg of bis (2-ethyhexyl) citraconate was added under mixing and subsequently stirred for 30 minutes.

21.4 kg titanium tetrachloride was placed in a 90 L reactor equipped with a mechanical stirrer at 14° C. Mixing speed was adjusted to 280 rpm. 19.6 kg of Mg-complex prepared above was added within 190 minutes keeping the temperature at 14° C. 0.47 kg of Viscoplex 1-254 was added. Then 12.6 kg of heptane was added to form an emulsion. Mixing was continued for 120 minutes at 14° C., before the reactor temperature was raised to 90° C. at a constant rate over 75 minutes. The reaction mixture was stirred for a further 60 minutes at 90° C. Afterwards stirring was stopped and the reaction mixture was allowed to settle for 90 minutes at 85° C.

The solid material was washed 7 times: Washings were made under stirring at 280 rpm, over 30 min. After stirring was stopped the reaction mixture was allowed to settle for 90 minutes, followed by siphoning, wherein the wash solution was removed. As a rule, the siphoning is conducted at the temperature of the following wash step.
Wash 1: Washing was made with a mixture of 24.9 kg of toluene and 0.37 kg of donor at 80° C.
Wash 2: Washing was made with a mixture of 24.9 kg of TiCl₄ and 0.49 kg of donor at 100° C.
Wash 3: Washing was made with a mixture of 24.9 kg of TiCl₄ and 0.49 kg of donor at 100° C.
Wash 4: Washing was made with 24.9 kg of toluene and 0.37 kg of donor at 80° C.
Wash 5: Washing was made with 27.0 kg of heptane at 75° C.
Wash 6: Washing was made with 30.3 kg of heptane at 55° C.
Wash 7. Washing was made with 30.3 kg of heptane at 55° C.

After the final siphoning step, white oil (Primol 325) was added at 55° C. at a stirring speed of 300 rpm. The resulting suspension was then dried under vacuum at 55° C. for 240 minutes at a stirring speed of 100 rpm yielding an air sensitive catalyst slurry

### Inventive Example 2

The same procedure was used as in Inventive Example 1, with the exception that, following the first addition of heptane, mixing was continued for 120 minutes at 14° C., before the reactor temperature was raised to 90° C. at a constant rate over 400 minutes.

### Comparative Example 1

The same procedure was used as in Inventive Example 1, with the exception that the temperature of Wash 2 was 80° C., Wash 3 was omitted, and no donor was used in Wash 4.

### Comparative Example 2

The same procedure was used as in Comparative Example 1, with the exception that 6 kg of heptane were added in the very first addition of heptane, following which, mixing was continued for 120 minutes at 14° C., before the reactor temperature was raised to 90° C. at a constant rate over 45 minutes

The properties of the catalyst particles thus obtained are summarized in Table 1.

TABLE 1
Composition and properties of the inventive and comparative catalysts

| | Ti | Mg | Donor | HC | 2-EHA | PGBE | d50 | | Yield |
|---|---|---|---|---|---|---|---|---|---|
| | (wt.-%) | (wt.-%) | (wt.-%) | (wt.-%) | (wt.-%) | (wt.-%) | (μm) | span | (%) |
| CE1 | 2.52 | 16.81 | 21.88 | 2.09 | 0.09 | 0.05 | 38 | 0.62 | 80 |
| CE2 | 2.52 | 16.60 | 17.53 | 0.63 | 0.81 | 0.53 | 35 | 0.50 | 66 |
| IE1 | 1.85 | 18.69 | 17.08 | 2.31 | 0.04 | 0.05 | 42 | 0.67 | 71 |
| IE2 | 1.87 | 18.75 | 16.70 | 2.37 | 0.00 | 0.00 | 44 | 0.32 | 76 |

The inventive catalysts show similarly high catalyst yields to those of the comparative catalysts, whilst having slightly lower titanium and donor contents, coupled with slightly higher magnesium content. The median particle size (d50) is also slightly larger.

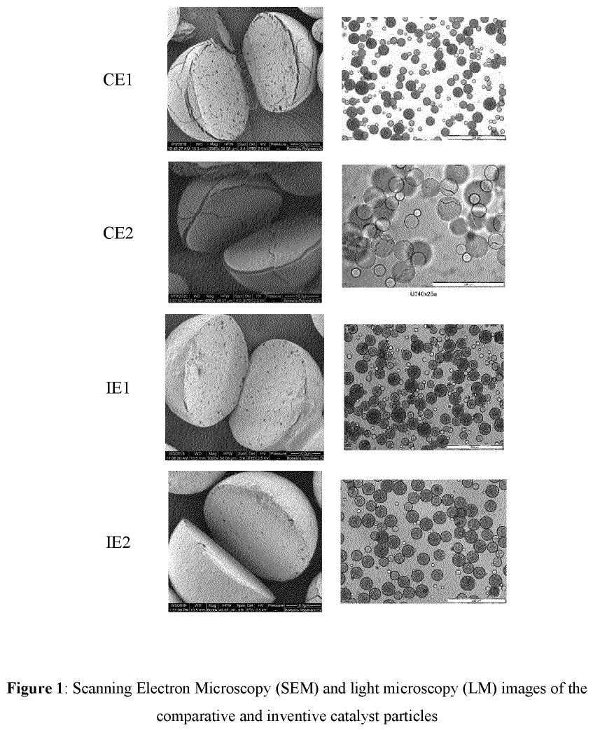

FIG. 1 further shows that the inventive catalyst particles display similar spherical morphology to the comparative catalyst particles, whilst demonstrating a more compact internal morphology with fewer internal voids or surface fractures, unlike CE1 in particular.

### b) Polymerization

To evaluate the performance of each of the catalysts, propylene polymerization was undertaken with each catalyst using the exact same conditions, as described below:

A 21.3 L autoclave reactor, equipped with helical stirrer, was purged with propylene, filled with 5300 g of liquefied propylene and maintained at 20° C. with stirring at 350 rpm. 1.22 ml of TEAI (0.582 M in heptane) was injected into the reactor for scavenging purposes and flushed with additional 250 g of propylene. 3 L of hydrogen was fed into the reactor and the reactor was allowed to stir for 20 min.

Meanwhile 59 mg of donor (D) (0.3 M in n-heptane) and 246 mg of TEAI (0.58 M in heptane) were mixed ([TEAI]/[D] molar ratio of 8.3:1) for 7 minutes, before being added to 38 mg of the solid catalyst precursor (supplied as a white oil slurry) component obtained in step a) ([TEAI]/[Ti] molar ratio of 100:1: [D]/[Ti] molar ratio of 12:1) to form the Ziegler-Natta catalyst system. Sufficient n-heptane was added to obtain a TEAl concentration of 0.1M. The components were allowed to contact for a total of 10 minutes.

The obtained Ziegler-Natta catalyst system slurry was injected into the reactor and flushed with an additional 450 g of propylene. The temperature was increased to 80° C. over 20 minutes and maintained at this temperature for 60 minutes, during which time a stirring rate of 350 rpm was maintained. During the temperature ramp, 9.8 L of hydrogen was added over 17 minutes. During the bulk polymerization at 80° C., no further propylene or hydrogen was added to the reactor.

After the bulk phase, the stirring rate was decreased to 100 rpm and the reactor was subsequently purged to a pressure of 0.5 barg. The stirring rate of the reactor was again increased to 350 rpm and the reactor was charged with propylene and hydrogen ([H2]/[C3] of 10 mol/kmol) as the temperature and the pressure were being increased to reach at 80° C. and 20 barg. Once the reactor temperature and pressure conditions had been reached, the reaction conditions were held constant for 180 minutes, during which time the pressure was held constant by suitably adjusting the monomer feed. Unreacted propylene and hydrogen were purged from the reactor to 0.5 barg with a stirring speed of 100 rpm. Residual gases were removed from the reactor by treating the reactor with several nitrogen/vacuum flashing cycles at 30° C., after which the polymer powder was collected, dried and weighed.

MFR₂, XCS, Tm and catalyst productivity data for each of the inventive and comparative catalysts are given in Table 2.

TABLE 2
Catalyst performance data

| | | CE1 | CE2 | IE1 | IE2 |
|---|---|---|---|---|---|
| Catalyst | Solid catalyst precursor | 30 | 40 | 40 | 46 |
| | (mg) | | | | |
| | Catalyst slurry conc. | 19.0 | 17.1 | 15.4 | 16.1 |
| | (wt.-%) | | | | |
| | Al:Ti in reactor | 147 | 126 | 146 | 139 |
| | (mol/mol) | | | | |
| Bulk | Activity (kgPP/g · | 47.4 | 44.6 | 34.2 | 29.5 |
| | cat · h) | | | | |
| | MFR₂ (g/10 min) | 11.5 | 10.0 | 7.0 | 7.0 |
| | Yield (g) | 1417 | 1765 | 1371 | 1358 |
| GPR | Activity (kgPP/g · | 6.2 | 6.2 | 6.0 | 5.0 |
| | cat · h) | | | | |
| | MFR₂ (g/10 min) | 10.4 | 8.4 | 6.6 | 6.2 |
| | GPR split (%) | 28.6 | 30.3 | 35.0 | 34.3 |
| | Yield (g) | 569 | 768 | 739 | 708 |
| Final | MFR₂ (g/10 min) | 11.2 | 9.5 | 6.9 | 6.7 |
| Polymer | XCS (wt.-%) | 2.37 | 2.28 | 1.87 | 1.92 |
| | Tm (° C.) | 164.8 | 165.1 | 165.9 | 166.0 |
| | Yield (g) | 1985 | 2532 | 2110 | 2065 |

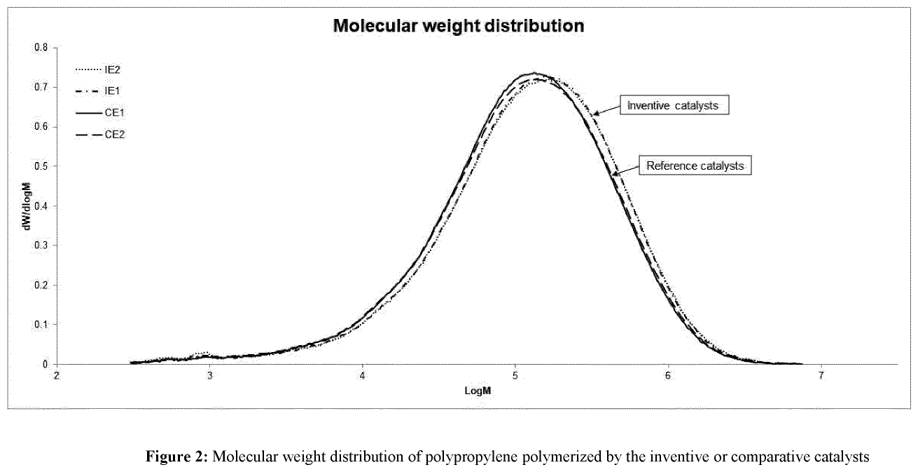

As can be seen from the data in Table 2, the inventive catalysts are able to produce propylene homopolymers with a lower MFR², lower XCS content and a higher melting temperature, which is indicative of higher molecular weight h-PP (see also FIG. 2) with higher crystallinity. Furthermore, the GPR split is notably higher than for the comparative catalysts, indicating that the activity of the catalysts experiences less decay throughout the process. This is especially important for multi-step sequential polymerization processes, which may involve three, four, or more sequential polymerization steps.

Without wishing to be bound by theory, it is believed that the higher wash temperature during the titanium tetrachloride washes (Wash 2 and Wash 3) leads to a modified crystal structure at the surface of the catalyst particles, which influences the catalytic properties, leading to the effects demonstrated in Table 2.

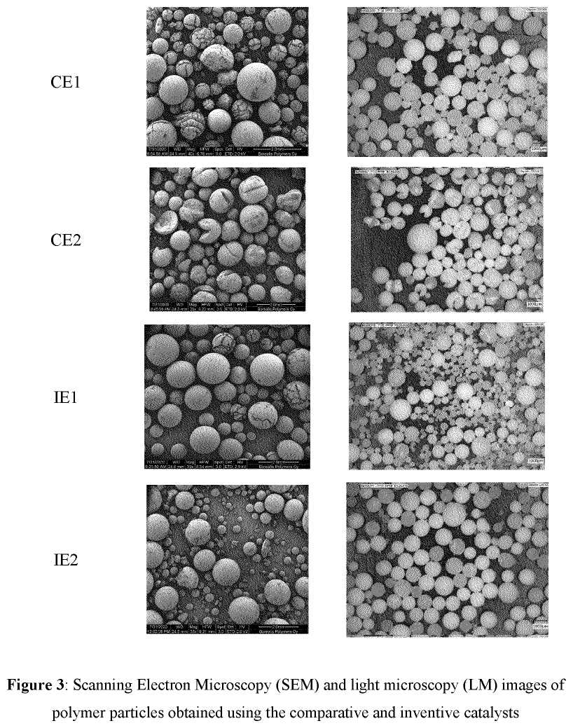

FIG. 2 reinforces the data in Table 2, showing a higher average molecular weight for the h-PP obtained using the inventive catalysts, whilst FIG. 3 shows that the obtained polymer particles when employing catalyst IEl show spherical particle morphology with negligible particle fracture and no polymer fines, IE2 and CE2 show negligible fractures and some polymer fines, whist CE1 exhibits both considerable polymer fracturing and some polymer fines.

1. A process for forming a Ziegler-Natta catalyst component, said process comprising, in the given order:
a) providing a solution of at least one magnesium component,
b) adding said solution from step a) to a titanium (IV) compound, obtaining thereby solid catalyst component particles as a suspension,
c) recovering said solid catalyst component particles from the suspension resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, and optionally internal electron donor (ID),
d2) one or more washes with a wash solution of titanium tetrachloride and internal electron donor (ID), and
d3) one or more washes with a wash solution of aromatic and/or aliphatic hydrocarbon,
wherein at least one of the one or more washes with a wash solution of titanium tetrachloride and internal electron donor (ID) of step d2) is conducted at a temperature in the range from 80 to 120° C.

2. The process according to claim 1, wherein the wash solution of step d1) is a wash solution of internal electron donor (ID) and aromatic and/or aliphatic hydrocarbon.

3. The process according to claim 1, wherein step d2) involves two or more washes with a wash solution of titanium tetrachloride and internal electron donor (ID).

4. The process according to claim 1, wherein all of the washes with a wash solution of titanium tetrachloride and internal electron donor (ID) of step d2) are conducted at a temperature in the range from 80 to 120° C.

5. The process according to claim 1, wherein the washing of step d) further comprises:
d4) one or more washes with a wash solution of internal electron donor (ID) and aromatic and/or aliphatic hydrocarbon, preferably selected from toluene, hexane or pentane,
wherein step d4) occurs after step d2) and before step d3).

6. The process according to claim 5, wherein the molar ratio between the amount of internal electron donor (ID) added in step d4) to the amount of magnesium in the Ziegler-Natta catalyst component ([ID]/[Mg]) is in the range from 0.01 to 0.20.

7. The process according to claim 1, wherein the non-phthalic internal electron donor is a non-phthalic diester.

8. The process according to claim 7, wherein the non-phthalic internal electron donor is selected from the group of maleates, citraconates, cyclohexene-1,2-dicarboxylates and any derivatives and/or mixtures thereof.

9. The process according to claim 1, wherein, following step e), the Ziegler-Natta catalyst component is further modified by a polymeric nucleating agent obtained by polymerizing a vinyl monomer of formula (I):
H₂C═CH—CHR¹R² (I),
wherein R¹ and R² independently represent a lower alkyl group containing 1 to 4 carbon atoms or, together with the carbon atom they are attached to, form an optionally substituted saturated, unsaturated or aromatic ring or a fused ring system, wherein the ring or fused ring moiety contains four to 20 carbon atoms.

10. A Ziegler-Natta catalyst composition comprising a Ziegler Natta catalyst component obtainable by the process according to claim 1.

11. The Ziegler-Natta catalyst composition according to claim 10, having a titanium content in the range from 1.00 to 2.40 wt.-%.

12. The Ziegler-Natta catalyst composition according to claim 10, wherein the weight ratio of titanium to magnesium ([Ti]/[Mg]) in said Ziegler-Natta catalyst composition is in the range from 0.06 to 0.14.

13. A process for the production of a polypropylene composition, comprising the polymerization of propylene, optionally with comonomers selected from C2 or C4 to C12 alpha olefins in the presence of a Ziegler-Natta catalyst system comprising a Ziegler Natta catalyst composition according to claim 10, a co-catalyst (Co) and optionally an external donor (ED).

14. A process for the production of a polypropylene composition, said process comprising, in the given order:
a) providing a solution of at least one magnesium component,
b) adding said solution from step a) to a titanium (IV) compound, obtaining thereby solid catalyst component particles,
c) recovering said solid catalyst component particles from the solution resulting from step b),
d) washing said solid catalyst component particles, and
e) recovering the solid catalyst component particles of the olefin polymerization catalyst component,
wherein an internal electron donor (ID) is added at any step prior to step c) and is a non-phthalic internal electron donor,
wherein the washing of step d) comprises, in the given order, the steps of:
d1) one or more washes with a wash solution of aromatic and/or aliphatic hydrocarbon, and optionally internal electron donor (ID),
d2) one or more washes with a wash solution of titanium tetrachloride and internal electron donor (ID), and
d3) one or more washes with a wash solution of aromatic and/or aliphatic hydrocarbon,
wherein at least one of the one or more washes with a wash solution of titanium tetrachloride and internal electron donor (ID) of step d2) is conducted at a temperature in the range from 80 to 120° C., and
polymerizing propylene, optionally with comonomers selected from C2 or C4 to C12 alpha olefins in the presence of a Ziegler-Natta catalyst system comprising a Ziegler Natta catalyst composition comprising the solid catalyst component recovered in step e), a co-catalyst (Co) and optionally an external donor (ED).

15. A use of the Ziegler-Natta catalyst composition according to claim 10, together with a co-catalyst (Co) and an optional external donor (ED), for the polymerization of propylene, optionally with comonomers selected from C2 or C4 to C12 alpha olefins.

16. The process according to claim 1, wherein at least one of the one or more washes with a wash solution of titanium tetrachloride and internal electron donor (ID) of step d2) is conducted at a temperature in the range from 85 to 120° C.

17. The process according to claim 4, wherein all of the washes with a wash solution of titanium tetrachloride and internal electron donor (ID) of step d2) are conducted at a temperature in the range from 85 to 120° C.

18. The process according to claim 1, wherein the wash solution of step d1) is a wash solution of aromatic and/or aliphatic hydrocarbon selected from toluene, hexane or pentane, and optionally internal electron donor (ID).

19. The process according to claim 1, wherein the wash solution of step d3) is a wash solution of aromatic and/or aliphatic hydrocarbon selected from toluene, hexane or pentane.

20. The process according to claim 2, wherein the wash solution of step d1) is a wash solution of internal electron donor (ID) and aromatic and/or aliphatic hydrocarbon, selected from toluene, hexane or pentane.
